(19) United States
(12) Patent Application Publication
(10) Pub. No.: US 2017/0204812 A1
(43) Pub. Date: Jul. 20, 2017

(54) HEAT EXCHANGE DEVICE

(71) Applicant: Borgwarner Emissions Systems Spain, S.L.U., Vigo (ES)

(72) Inventors: José Antonio Grande Fernández, Vigo (ES); Pedro Río, Foz Do Sousa (PT)

(73) Assignee: Borgwarner Emissions Systems Spain, S.L.U., Vigo (ES)

(21) Appl. No.: 15/405,690

(22) Filed: Jan. 13, 2017

(30) Foreign Application Priority Data
Jan. 19, 2016 (EP) 16382019.4

(51) Int. Cl. F02M 26/32; F28F 9/12; F28F 21/08; F28F 9/013

(52) U.S. Cl. CPC F02M 26/32; F28F 9/0131; F28F 9/12; F28F 21/084; F28F 2265/26; F01P 3/00

(57) ABSTRACT

A heat exchange device suitable for cooling recirculated exhaust gases in an EGR (Exhaust Gas Recirculation) system includes a configuration which allows integrating the heat exchanger in a cavity of the engine block of an internal combustion engine with the cavity being in fluid communication with the liquid coolant of the engine.

### FIELD OF THE INVENTION

The present invention relates to a heat exchange device suitable for cooling recirculated exhaust gases in an EGR (Exhaust Gas Recirculation) system.

The invention is characterized by a configuration which allows integrating the heat exchanger in a cavity of the engine block of an internal combustion engine with fluid communication with the liquid coolant.

The present invention has an impact on protecting the environment.

### BACKGROUND OF THE INVENTION

One of the technical fields experiencing the most intensive development is that of systems for reducing contaminating emissions in internal combustion engines.

In particular, EGR systems recirculate exhaust gas by reintroducing a portion of said gas into the intake to reduce the amount of oxygen entering the combustion chambers, and as a consequence reduce nitrogen oxide emission.

The recirculated gas must be pretreated to prevent it from having dirt particles and to prevent its temperature from being high. These recirculated gas treatments allow preventing the combustion chambers from getting dirty and the intake air temperature from increasing, which gives rise to a reduced filling and therefore a drastic reduction in engine power.

The devices needed for obtaining this recirculated gas treatment take up space and require conduits conveying the gas from the acquisition point in the exhaust line to the intake, going through each of the components that the EGR system requires.

One of the greatest drawbacks of incorporating additional components in an internal combustion engine is the little space available in the engine bay. The packaging required by the addition of components conditions the shape of the devices and their position.

When two different devices are located in separate gaps of the engine bay, there is an additional penalization due to the need of extending a conduit communicating both devices. Both the devices and these conduits connecting them are taking up the limited available space which furthermore complicates engine assembly and maintenance.

An essential component in an EGR system is the heat exchanger cooling the exhaust gas to adapt it to the intake temperature. The most common heat exchangers allow hot gas to pass through a bundle of tubes which is housed in a shell. A liquid coolant evacuating heat from the hot gas is allowed to pass between the shell and the bundle of tubes cooling the tubes of the bundle of tubes. In turn, the heat removed by the liquid coolant is evacuated to the atmosphere by means of a radiator.

With this heat exchanger structure, the shell is a resistant element which serves to keep the baffles and the inlet and outlet manifolds separated. The heat exchange tubes extend between these baffles.

The assembly forms a device which is housed in the engine bay and requires fluid connections so that the liquid coolant circulating between the engine block and the radiator also passes through this heat exchanger which allows cooling the exhaust gases.

### BRIEF SUMMARY OF THE INVENTION

The present invention solves the problems identified above by means of a heat exchanger structure which allows integrating the heat exchanger in the engine block such that said heat exchanger is housed in a cavity which is covered in the liquid coolant of the engine.

In addition to not taking up the space which the heat exchanger would use as an independent device, it also prevents fluid connections of the liquid coolant.

According to one or more embodiments of the invention, fluid connections of cooled gas outlet are also prevented.

An aspect of the invention relates to a heat exchange device configured for being installed in a cavity provided in the engine block of an internal combustion engine.

The liquid coolant of the engine flows through this cavity such that the device does not require liquid coolant inlet and outlet conduits saving components and also conduits that take up space in the engine bay.

The cavity has a perimetral seat on which the device rests closing the cavity, such that the device is integrated with the engine block.

The device comprises:

a structural element which in turn comprises a plate, a first support and a second support, wherein:

the plate has an inner face and an outer face, the inner face configured for being oriented towards the cavity, and wherein said plate comprises on its inner face a seat configured for resting on the perimetral seat of the cavity of the engine block;

the first support is located on the inner face of the plate; and,

the second support is also located on the inner face of the plate,

a bundle of heat exchange tubes located on the side of the inner face of the plate, an end of the bundle of tubes fixed in the first support and the opposite end of the bundle of tubes fixed in the second support.

The device comprises a structural element, structural element being understood as an element which is capable of securing different components, this is a supporting function; and it is furthermore capable of withstanding the stresses generated in the set of elements making up the exchanger. In other words, not only are the components of the device fixed to this structural element but rather stresses due, for example, to the assembly, thermal expansions, inertial stresses, etc., can appear between elements and such stresses are transmitted to the structural element without requiring additional structural elements leading to the engine block. The most significant stresses are those due to thermal expansions of the bundle of tubes and the present invention establishes this structural element as the one responsible for absorbing these stresses without them being transmitted to the engine block or in other words without the need of the engine block having to be part of the elements conferring structural stability to the device.

The structural element is mainly formed by three elements, a plate and two supports. The plate is not only the base element of the structural element but also serves to establish the closure of the cavity where the device is housed; i.e., the heat exchanger. The closure is achieved through the seat which is configured for resting on the perimetral seat of the cavity of the engine block.

The plate defines two faces, an inner face and an outer face. The inner face is intended for being located inside the cavity and is therefore on the side which is in contact with the liquid coolant. The outer face is located outside the cavity after being assembled in the engine block.

This same structural element has a first support and a second support. Each of the supports can be configured as an integral part of the plate or as an independent part firmly attached with said plate provided that it forms a single resistant element with the plate once attached.

The heat exchange tubes extend between both supports. These supports allow the bundle of tubes to extend inside the cavity and to be covered by the liquid coolant. The inertial movements of the bundle of tubes or the stresses generated by thermal expansion are transmitted to the first and second supports which in turn transmit them to the plate. Therefore, without resistant elements starting from the inside of the cavity all the main elements of the heat exchanger are suitably fixed and supported with the resistant element closing the cavity.

According to embodiments, the tubes can incorporate additional elements at intermediate segments or points of the length thereof which are fixed to the resistant element to reduce vibrations due to inertial stresses acting on the bundle of tubes.

Additionally,

the first support comprises a first internal chamber which is in fluid communication with the outer face of the plate through a first opening of said plate and also in fluid communication with the inside of the exchange tubes at one of the ends of the bundle of tubes; and,

the second support comprises a second internal chamber which is in fluid communication with a recirculated gas intake opening of the engine block and also in fluid communication with the inside of the exchange tubes at the opposite end of the bundle of tubes.

In other words, the heat exchange tubes of the bundle of tubes are mainly fixed through their ends by means of the first and second supports. Additionally, these supports comprise an internal chamber, the so-called first internal chamber and second internal chamber, respectively, which is in fluid communication with the inside of the tubes and with the inlet or outlet of the gas to be cooled.

In the case of the first support, the internal chamber is in fluid communication with the outer face of the plate. This fluid communication receives the input of hot gas from the exhaust conduit so that it can go into the heat exchange tubes reducing their temperature by transferring the heat thereof to the liquid coolant of the cavity.

In the case of the second support, the second internal chamber is in fluid communication with the intake which is located in the engine block.

According to first embodiments, the intake of the engine block through which the already cooled recirculated gas is introduced for being mixed with the air from the atmosphere is accessible from an opening outside the cavity and separated from the latter. There are provided in these embodiments means so that the second internal chamber is in fluid communication with chambers or conduits located on the outer face for subsequently being introduced through this opening of the engine block.

According to second embodiments, the intake of the engine block through which the already cooled recirculated gas is introduced for being mixed with the air from the atmosphere is accessible from an opening located within the cavity. Liquid coolant cannot enter this opening. In these embodiments, the second internal chamber is in fluid communication with the opening for introducing the gas which has been cooled to the intake of the engine.

These embodiments will be described with greater detail using the drawings.

### BRIEF DESCRIPTION OF THE DRAWINGS

These and other features and advantages of the invention will be more clearly understood from the following detailed description of a preferred embodiment, given solely by way of illustrative and non-limiting example in reference to the attached drawings.

FIG. 1 shows a first embodiment of the invention in a longitudinal section following the direction of the exchange tubes. The device is suitable for internal combustion engines wherein the cavity receiving the device and the intake opening of the recirculated gas are separated.

FIG. 2 shows a perspective view of the same embodiment without the engine block wherein the bundle of tubes together with a set of elements linked with the bundle of tubes are shown separated to allow observing specific details of the device.

FIG. 3 shows a longitudinal section, also following the direction of the exchange tubes, of a second embodiment of the invention. The configuration is like that of the first embodiment except that the chambers and ducts defining the path of the cooled gas have less abrupt direction changes to minimize pressure losses and the supports are not integrated with the plate.

FIG. 4 shows a third embodiment suitable for being installed in cavities of the engine block wherein said cavity incorporates the inlet opening of the recirculated gas once it has been cooled. This drawing shows a top view. For the sake of clarity, the schematic representation of the engine block has been eliminated in this drawing and in the two subsequent drawings to facilitate visual access to the device.

FIG. 5 shows the same embodiment according to a longitudinal section.

FIG. 6 shows the same embodiment according to a perspective view with an exploded view of some of the parts of the same embodiment to allow observing some configurative details of the device.

### DETAILED DESCRIPTION

According to the first inventive aspect, the present invention relates to a device for heat exchange which can be integrated in the engine block. In all the embodiments, heat exchange will be carried out between a hot gas, the recirculated gas coming from the exhaust conduit of the internal combustion engine, and a liquid coolant, the liquid coolant circulating through the inside of the engine block (E).

According to all the embodiments that will be described, the exchange devices are configured for being housed in a cavity (C) provided in the engine block (E). Liquid coolant is also envisaged to flow in this cavity (C) for evacuating heat given off by the hot gas through the heat exchange device.

The same engine block (E) also has an opening (R) for accepting the recirculated gas after it has been cooled by the device.

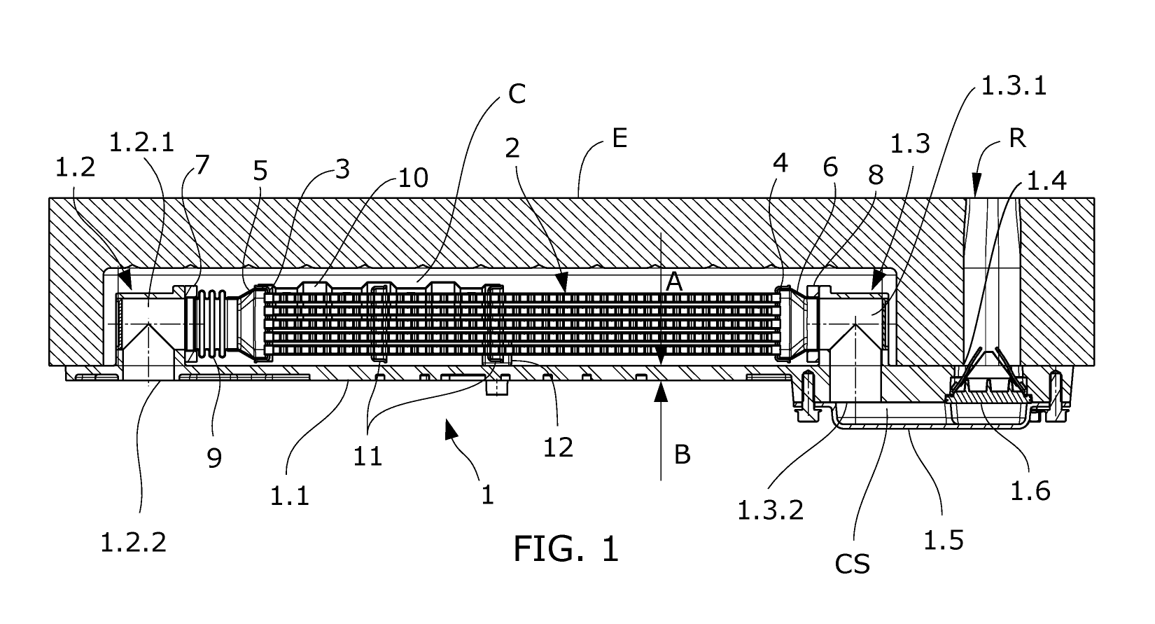

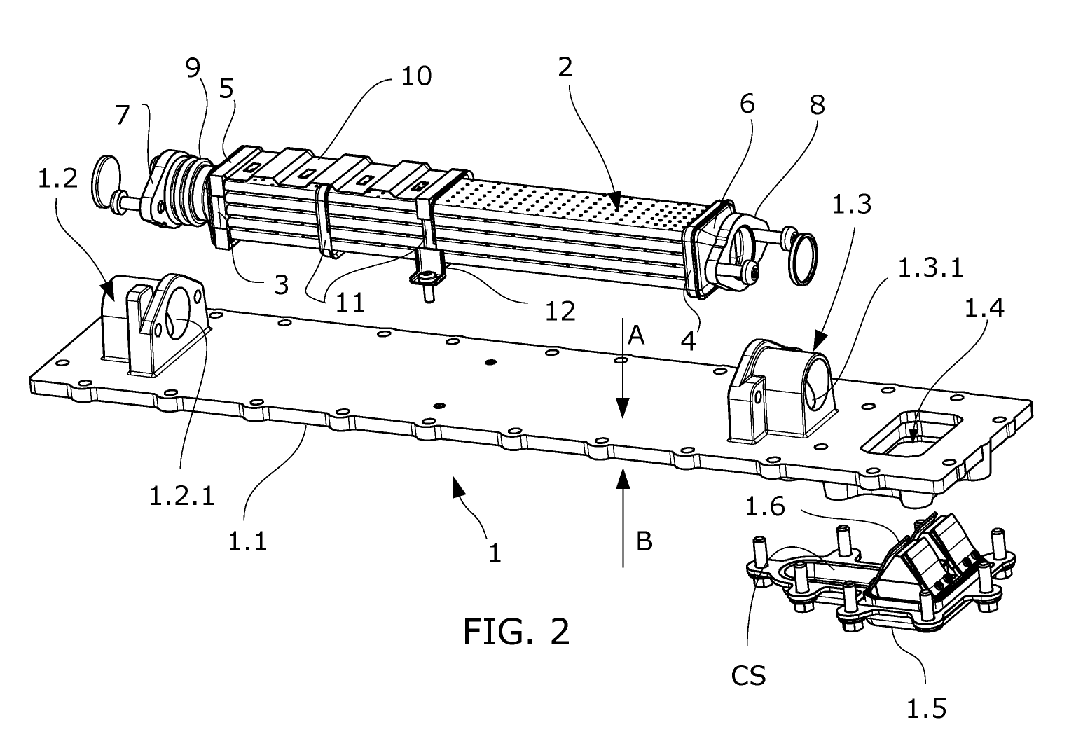

FIG. 1 shows a longitudinal section of a first embodiment as well as a schematic representation of the engine block (E) and the cavity (C) present in said engine block (E) intended for housing the heat exchange device. In this cavity (C) there are accesses to conduits communicating with other portions of the engine block (E), although they are not shown in FIG. 1, through which the liquid coolant circulates. FIG. 2 shows in an exploded perspective view the most relevant components of this same embodiment.

The longitudinal direction will be identified in all the cases with the direction in which the heat exchange tubes of the bundle of tubes (2) used for transferring heat from the hot gas to the liquid coolant extend.

In FIG. 1 the opening of the cavity (C) is oriented downwards according to the orientation of the drawing chosen for the graphical representation thereof.

Throughout the description of the embodiments, if positional terms such as up, down, right or left are used, they must be interpreted as terms referring to the orientation shown in the drawings according to the orientation that has been chosen.

The heat exchange device is formed by a structural element (1) comprising a plate (1.1), a first support (1.2) and a second support (1.3). The plate (1.1) is shown in the lower portion covering the opening of the cavity (C) and making up the closure thereof.

The plate (1.1) defines an inner face (A), the face oriented towards the cavity (C) and that is-the face which is in contact with the liquid coolant; and an outer face (B), the face facing outside the engine block (E).

The cavity (C) of the engine block (E) has a perimetral seat, not shown in FIG. 1, on which the plate (1.1) is supported. The plate (1.1) also has a seat on the inner face (A) in turn resting on the perimetral seat of the cavity (C) achieving the leak-tightness which prevents the exit of the liquid coolant. The means which allow fixing the structural element (1) in the engine block (E) are also located in the perimetral zone of the cavity (C).

The plate (1.1) of this embodiment is manufactured by aluminum injection. Nevertheless, this plate (1.1) can be obtained by machining from a metal block, by stamping or even by attaching smaller parts provided that they form a resistant structural element once attached. Another alternative is that the plate (1.1) is made of injected or machined plastic with sufficient resistance so as to give rise to a resistant structural element.

On the inner face (A) there emerge the two supports, the first support (1.2) and the second support (1.3).

The bundle of tubes (2) extends between the first support (1.2) and the second support (1.3) such that the bundle of tubes (2) is arranged parallel to the plate (1.1) and separated from the latter (1.1). In this position, the bundle of tubes (2) is housed in the space of the cavity (C) arranged so that in operative mode the liquid coolant covers all the tubes of the bundle of tubes (2) evacuating heat from the gas circulating through the inside thereof.

In this embodiment, the tubes of the bundle of tubes (2) are attached to a first baffle (3) at one end and to a second baffle (4) at the opposite end, each of the baffles (3, 4) being prolonged by means of a first and second manifold (5, 6).

The first support (1.2) has a first internal chamber (1.2.1) and the second support (1.3) has a second internal chamber (1.3.1). The first internal chamber (1.2.1) is in fluid communication with a first opening (1.2.2) of the plate (1.1) such that it accepts the hot gas it receives from the exhaust conduit of the internal combustion engine. The configuration of the internal chamber (1.2.1) according to the longitudinal section is in L shape. The flow entering according to a direction perpendicular to the plate (1.1) is diverted to flow in a direction parallel to the plate through the bundle of tubes (2) giving off the heat thereof.

Once the fluid has exited the first internal chamber (1.2.1) the flow is distributed through the plurality of tubes of the bundle of tubes (2) by means of the first manifold (5).

The hot gas gives off heat to the liquid coolant and moves out to the second manifold (6) which in turn communicates with the second internal chamber (1.3.1). This second internal chamber (1.3.1) also has an L configuration diverting the flow in a direction perpendicular to the bundle of tubes (2) to allow exit crossing the main plane defined by the plate (1.1).

In this embodiment, the opening (R) in the engine block (E) for the intake of the recirculated gas after it has been cooled is located outside the cavity (C). In this same embodiment, the structural element (1) is prolonged covering the mentioned recirculated gas intake opening (R), leaving an access through a third opening (1.4) of the plate (1.1), and provides a duct so that the cooled gas that leaves through the second opening (1.3.2) enters said opening (R).

In the zone corresponding both to the second opening (1.3.2) of the plate (1.1) through which the cooled gas exits and to the third opening (1.4) of the plate (1.1) through which the cooled gas enters for accessing the opening (R) of the engine block (E), the plate (1.1) is thickened and covered by a cover (1.5) giving rise to a secondary chamber (CS).

This secondary chamber is in fluid communication with the second internal chamber (1.3.1) and is also in fluid communication with the recirculated gas intake opening (R) located in the engine block (E). This secondary chamber (CS) transfers the recirculated gas after it has been cooled to the intake opening (R) without needing conduits communicating two devices separated from one another. This configuration prevents using the space of the bay of the vehicle housing the engine.

The thickened zone of the plate (1.1) has two check valves (1.6) causing a single direction of flow. The number of check valves (1.6) depends on the flow requirements. The higher the number of check valves (1.6), the greater the gas flow which can be conducted to the recirculated gas intake opening (R) will be.

In this embodiment, applicable to any embodiment of the invention, between the first manifold (5) and the first support (1.2) there is an elastically deformable conduit (9) compensating for the length variations of the bundle of tubes (2) due to temperature changes.

Additionally, the assembly formed by the bundle of tubes (2), the manifolds (5, 6) and the elastically deformable conduit (9) configure an assembly that can be assembled in and disassembled from the first support (1.2) and the second support (1.3), respectively. At the gas input end in the assembly there is a first flange (7) which is attached by screwing to the first support (1.2) and at the opposite end there is a second flange (8) which is attached by screwing to the second support (1.3).

In this embodiment, applicable to any embodiment of the invention in which an elastically deformable conduit (9) is used, the distance of the assembly between the flanges (7, 8) when it is cold in the moment of assembly is less than the distance between the first support (1.2) and the second support (1.3). The screwed attachment of the flanges can be completed because tightening the flanges imposes the extension of the elastically deformable conduit (9).

This configuration has the advantage that the expansion of the assembly due to the rise in temperature has two phases: a first phase of compensating for the traction caused by the forced screwed attachment; and a second phase caused by the compressing of the elastically deformable conduit (9). If the assembly were not previously pulled by means of the forced attachment the elastically deformable conduit (9) would only work under compression. By distributing the tensional state into a first traction phase and a second compression phase, the maximum tension under which the elastically deformable element (9) works is limited, thus increasing the service life thereof.

In this embodiment, the bundle of tubes (2) has a deflector (10) covering a portion of the periphery of the bundle for guiding the flow entering the cavity (C). The guiding forces the incoming liquid coolant flow to penetrate the bundle of tubes (2) mainly in the zone closest to the hot gas inlet.

A particular way of feeding the cavity (C) with liquid coolant is to provide liquid coolant inlet openings distributed along the length of the cavity (C). The transverse flow hits the deflector (10) and, since in this example the deflector (10) is open in a side segment along the longitudinal direction, the transverse flow forces a convection flow through the inside of the bundle of tubes (2).

In this embodiment, the bundle of tubes (2) also comprises intermediate baffles (11) which assure the distance between the tubes of the bundle of tubes (2), modify the liquid coolant flow and also improve the dynamic behavior due to the vibrations generated by inertial stresses.

In the central portion of the bundle of tubes (2) in this embodiment an intermediate support (12) has been incorporated reducing the amplitude of oscillations due to inertial stresses of the bundle of tubes (2) and therefore reducing the mechanical fatigue and stresses in the attachment of the tubes due to vibrations.

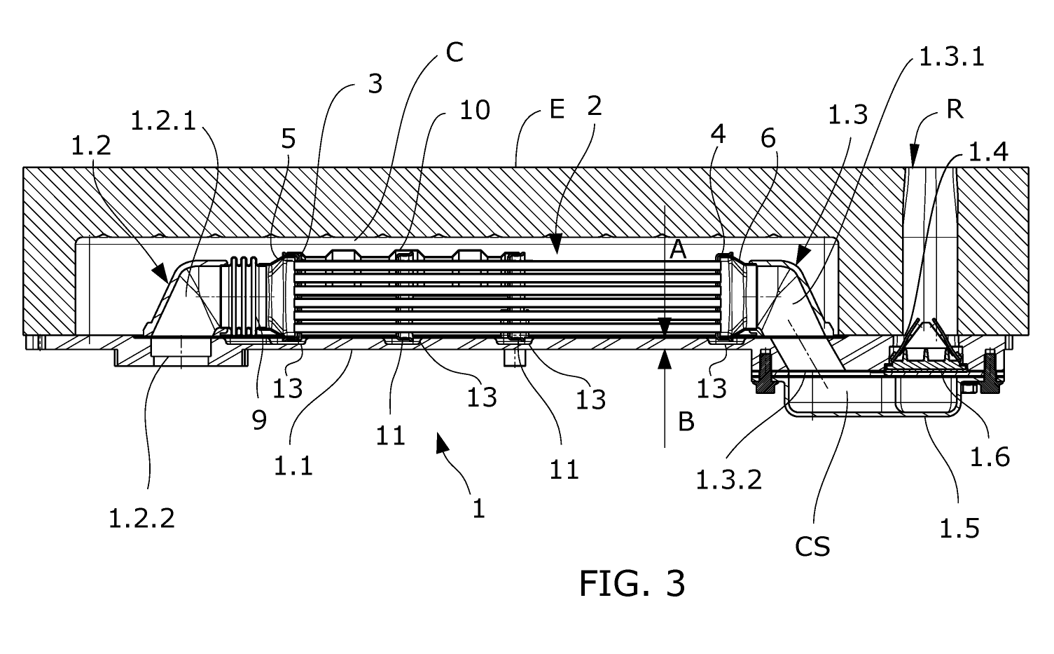

FIG. 3 shows according to a longitudinal section a second embodiment sharing a large number of components and the configuration of the first embodiment. For this reason, only the elements that are different from the first embodiment are described in this second embodiment.

This second embodiment is more compact than the first embodiment and offers a lower pressure drop in the passage of gas.

The lower pressure drop is due to the fact that the L configurations of the first internal chamber (1.2.1) of the first support (1.2) and of the second internal chamber (1.3.1) of the second support (1.3) have a more open angle, i.e., the angle of the “L” is greater such that the angle of change of direction of flow is smaller both at the inlet and the outlet.

Likewise, the passage of the recirculated and cooled gas towards the secondary chamber (CS) going through the thickened zone of the plate (1.1) is through a conduit prolonging the outlet in a smaller angle, i.e., passes according to an oblique direction causing the arrival to the secondary chamber (CS) to also have a change of direction with a smaller angle.

All these changes of direction with a smaller angle give rise to lower pressure drops and do not prevent the first support (1.2) and the second support (1.3) from remaining facing one another such that the assembly formed by the bundle of tubes (2), the first manifold (5), the second manifold (6) and the elastically deformable conduit (9) are interposed between said first and second supports (1.2, 1.3).

In this embodiment where the length is somewhat shorter, flanges (7, 8) which in the first embodiment allowed pulling of the assembly located between the first support (1.2) and the second support (1.3) have been omitted. The intermediate support (12) has also been omitted. Nevertheless, the assembly has been configured more compact by moving the bundle of tubes (2) closer to the plate (1.1). Since the intermediate baffles (11) and the manifolds (5, 6) project from the perimeter of the bundle of tubes (2), they are partially housed in grooves (13) located on the inner face (A) of the plate (1.1).

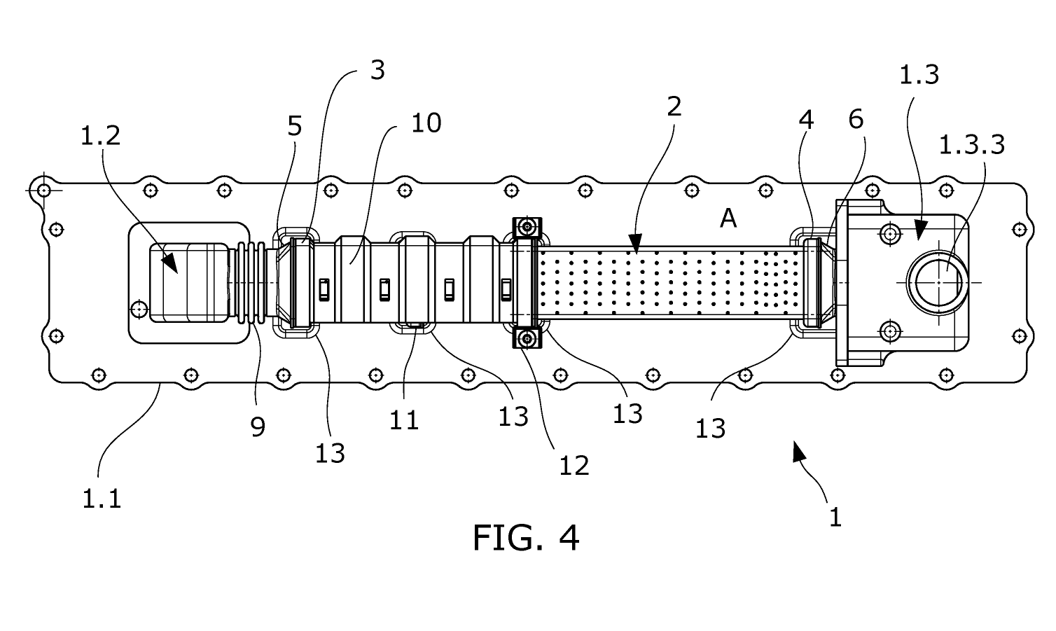

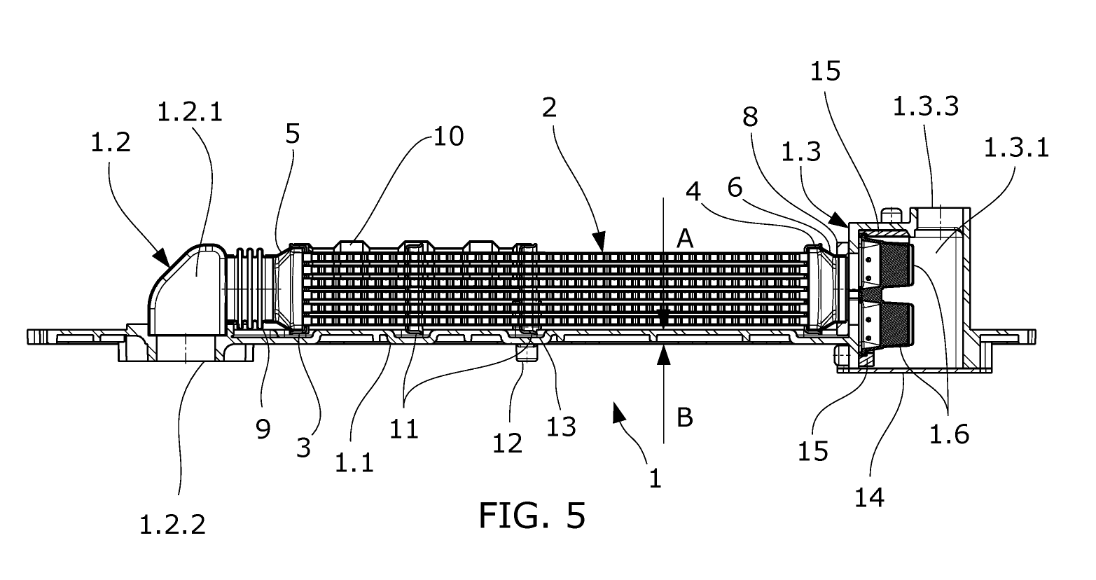

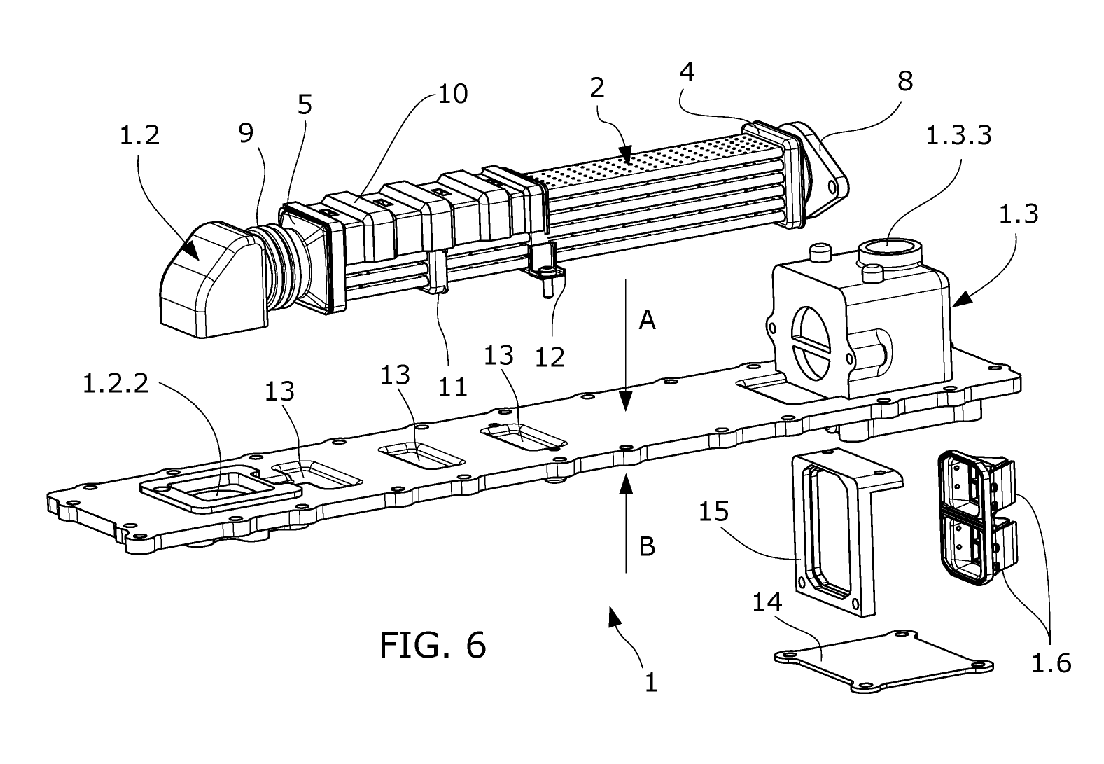

FIGS. 4, 5 and 6 show a third embodiment. FIG. 4 shows the heat exchange device according to a top view, FIG. 5 shows a longitudinal section and FIG. 6 shows an exploded perspective view. None of these three drawings include a representation of the engine block (E) or the cavity (C) to facilitate visual access to each of the components of the device.

This embodiment allows cooling the hot gas coming from the exhaust conduit and introducing the gas once cooled through the recirculated gas intake opening (R) when said opening (R) is located within the cavity (C).

The structure of the device has as a base the structural element (1) formed by a plate (1.1) and two supports, a first support (1.2) shown on the left side and a second support (1.3) shown on the right side.

The first support (1.2) has therein an internal chamber (1.2.1) with a configuration according to its chamfered arch section for guiding the incoming gas flow in the 90° change of direction, i.e., to adapt the direction of gas entry according to a direction perpendicular to the plate (1.1) through the first opening (1.2.2) of the plate (1.1) to the direction of the bundle of tubes (2) extending parallel to the plate (1.1).

Between the bundle of tubes (2) and the first support (1.2) there is an elastically deformable conduit (9) connecting the outlet of the first internal chamber (1.2.1) and the first manifold (5) responsible for distributing the incoming gas in the tubes of the bundle of tubes (2).

The bundle of tubes (2) shows two intermediate baffles (11) assuring the distance between tubes and a deflector (10) improving the convection of the liquid coolant between the tubes of the bundle of tubes (2) mainly on the hot gas inlet side.

The bundle of tubes (2) is located very close to the plate (1.1) of the structural element (1). Since the intermediate baffles, the first manifold (5) and the second manifold (6) have perimetral dimensions greater than the bundle of tubes (2), they are partially housed in grooves (13) located in the plate (1.1).

The cooled gas runs into the second manifold (6) which in turn communicates with the second internal chamber (1.3.1) of the inside of the second support (1.3). This second support (1.3) and its internal chamber (1.3.1) is of greater dimensions and is not communicated with the outside of the cavity (C) since it conducts the cooled gas directly to the recirculated gas intake opening (R) which is located in the same cavity (C).

The opening (R) is not shown in FIGS. 4 to 6 given that the engine block (E) is not shown. Nevertheless, a second opening (1.3.3) of the second support (1.3) directly communicates with the opening (R) of the engine block (E) significantly reducing pressure drops since the gas does not have to follow the winding passages required by the presence of a secondary chamber (CS) as occurs with the first and second embodiments.

The configuration of the second support (1.3) according to this third embodiment is of greater dimensions since the second internal chamber houses the check valves (1.6).

The second internal chamber (1.3.1) is accessible by removing a cover (14). The opening left by removal of the cover (14) allows access to the inside of the second chamber (1.3.1) to facilitate the insertion of the check valves (1.6) and assembly.

In the perspective view shown in FIG. 6, the cover (14) and a frame (15) for securing the check valves (1.16) are observed.

With this configuration the gas exiting the bundle of tubes (2) enters the second internal chamber (1.3.1) and must only be rotated 90° for being oriented according to the exit direction of the second opening (1.3.3) of the second support (1.3) for accessing the recirculated gas intake opening (R) reducing the number of changes of direction and therefore pressure losses generated by said changes of direction.

1. A heat exchange device configured for the installation thereof on the perimetral seat of a cavity of an engine block of an internal combustion engine, said cavity being in fluid communication with the liquid coolant of the engine, said device comprising:
a structural element comprising a plate, a first support and a second support, wherein:
the plate has an inner face and an outer face, the inner face configured for being oriented towards the cavity, and wherein said plate comprises on the inner face a seat configured for resting on the perimetral seat of the cavity of the engine block;
the first support is located on the inner face of the plate; and,
the second support is located on the inner face of the plate,
a bundle of heat exchange tubes located on the side of the inner face of the plate, an end of the bundle of tubes fixed in the first support and an opposite end of the bundle of tubes fixed in the second support,
wherein
the first support comprises a first internal chamber in fluid communication with the outer face of the plate through a first opening of said plate and also in fluid communication with the inside of the exchange tubes at one of the ends of the bundle of tubes; and,
the second support comprises a second internal chamber in fluid communication with a recirculated gas intake opening of the engine block and also in fluid communication with the inside of the exchange tubes at the opposite end of the bundle of tubes.

2. The device according to claim 1, wherein the structural element comprises a secondary chamber located on the side of the outer face of the plate and wherein:
the second internal chamber is in fluid communication with the secondary chamber through a second opening of the plate; and,
the secondary chamber is in fluid communication with the intake of the engine block either through the second opening of the plate or through a third opening of the plate,
to allow supplying cooled gas through a recirculated gas intake opening when the latter is located outside the cavity of the engine block.

3. The device according to claim 1, wherein the second internal chamber is in fluid communication with a recirculated gas intake opening of the engine block wherein this fluid communication and the opening are located entirely in the cavity of the engine block.

4. The device according to claim 1, wherein the first support, the second support or both are two facing conduits configured in “U”.

5. The device according to claim 1, wherein at one or both ends of the heat exchanger, the ends of the heat exchange tubes of the bundle of tubes are attached to a baffle attached to a manifold, the inside of said manifold in fluid communication with the inside of the exchange tubes attached to the baffle, the manifold being that which is in fluid communication with the internal chamber of the corresponding support.

6. The device according to claim 5, wherein at least one of the manifolds has flanges for attachment to the corresponding support thereof such that at least the assembly formed by the bundle of tubes, the baffles and the manifolds with the flanges form a module that can be coupled on the supports.

7. The device according to claim 1, wherein said device comprises at least at one of the ends of the bundle of tubes an elastically deformable conduit interposed between the manifold and the support for absorbing the differential expansion between the plate and the bundle of tubes.

8. The device according to claim 7, wherein the elastically deformable conduit has a bellows configuration.

9. The device according to claim 6, wherein said device comprises at least at one of the ends of the bundle of tubes an elastically deformable conduit interposed between the manifold and the support for absorbing the differential expansion between the plate and the bundle of tubes, and
wherein the distance between the flanges is less than the length of the module that can be coupled on the supports such that the attachment of the flanges of said module is by the pulling deformation of the elastically deformable conduit.

10. The device according to claim 1, wherein the bundle of tubes has a deflector for channeling the fluid coolant towards the bundle of tubes.

11. The device according to claim 10, wherein the deflector is open on at least one of the sides of the bundle of tubes.

12. The device according to claim 1, wherein the structural element is a part:
made of injected aluminum,
made of machined aluminum,
made of injected aluminum with machined finish in some of its portions,
or made of injected plastic.

13. The device according to claim 1, wherein the structural element comprises two or more portions welded to one another.

14. An EGR system comprising an exhaust gas cooling device comprising:
configured for the installation thereof on the perimetral seat of a cavity of an engine block of an internal combustion engine, said cavity being in fluid communication with the liquid coolant of the engine, said device comprising:
a structural element comprising a plate, a first support and a second support, wherein:
the plate has an inner face and an outer face, the inner face configured for being oriented towards the cavity, and wherein said plate comprises on the inner face a seat configured for resting on the perimetral seat of the cavity of the engine block;
the first support is located on the inner face of the plate; and,
the second support is located on the inner face of the plate,
a bundle of heat exchange tubes located on the side of the inner face of the plate, an end of the bundle of tubes fixed in the first support and an opposite end of the bundle of tubes fixed in the second support,
wherein
the first support comprises a first internal chamber in fluid communication with the outer face of the plate through a first opening of said plate and also in fluid communication with the inside of the exchange tubes at one of the ends of the bundle of tubes; and,
the second support comprises a second internal chamber in fluid communication with a recirculated gas intake opening of the engine block and also in fluid communication with the inside of the exchange tubes at the opposite end of the bundle of tubes.
